(19) United States
(12) Patent Application Publication
(10) Pub. No.: US 2003/0122858 A1
(43) Pub. Date: Jul. 3, 2003

(54) Partial identification and usage of objects in virtual worlds

(76) Inventor: Martin Mauve, Mannheim (DE)

Correspondence Address: Kohler Schmid + Partner, Ruppmannstr. 27, Stuttgart, D-70565, DE

(21) Appl. No.: 10/033,907

(22) Filed: Jan. 3, 2002

(51) Int. Cl. G09G 5/00

(52) U.S. Cl. 345/706

(57) ABSTRACT

A method for using, presenting, transmitting and storing objects in and by virtual worlds defines the object as a sequence of modifications. A virtual world in which an object modification occurs is identified and each modification of the object, and the associated virtual world in which that modification has been made, is stored. In this manner, users may transfer objects from one virtual word to a different one in a way that allows the virtual world to which the object is taken to decide which modifications of the object are acceptable.

### BACKGROUND OF THE INVENTION

The invention concerns a method for using, presenting, transmitting, and storing objects in and by virtual worlds.

A virtual world is a simulation of the real world or a simulation of an imaginary world. Humans can participate in this simulation. While they do so, they are able to interact with objects that are part of the virtual world. Amongst others, these objects can be representations of items or of human participants.

It is typically desirable to be able to take objects from one virtual world to a different one. However, there is a problem with this: an object might have been modified in one virtual world in a way that is not acceptable for the virtual world to which the user wants to take the object. In this context, two virtual worlds are considered to be different from each other if an object can be modified within one virtual world in a way that is not acceptable for the other virtual world.

Currently, there exist the following approaches for taking an object from one virtual world to another one:

1. All virtual worlds accept all modifications of an object that have been performed by arbitrary other virtual worlds. This approach is used by the company Blizzard for their product Diablo®.

2. An object can be exchanged between virtual worlds only if the persons or organizations that are responsible for the virtual worlds trust each other. In particular, this is the case when the persons or organizations that are responsible are identical for both virtual worlds. This approach is used by the companies Verant® and Sony® for their Everquest® product, with which the representation of a user can occasionally be transferred to a new virtual world.

3. If an object is to be brought into a virtual world, the virtual world requests this object from a trusted central institution. This institution hands the object to the virtual world, where it can be modified. When the object leaves the virtual world it is handed back to the trusted central institution. At this point, the institution uses a set of rules to decide whether or not the modifications to the object are acceptable. If this is not the case the object may be rejected, reset to the state that it had before it was transferred to the virtual world, or it may be adapted so that the overall modification obeys the rule set. This solution will be used by the company Interplay® for their product Neverwinternights®.

The existing approaches have the following problems and limitations:

Approach 1:

This approach does not assure that an object is not modified within a virtual world in a way that is not acceptable for a different virtual world to which the object is taken.

Approach 2:

This approach limits the virtual worlds between which objects can be exchanged. An object can be brought from one virtual world to a different one only if the persons/organizations that are responsible for each virtual world trust each other completely. Typically this will only be the case if the persons/organizations responsible for the virtual world are identical for both virtual worlds.

Approach 3:

With this approach, it is still possible that objects are modified in a way that is not acceptable for a given virtual world. The modification is only limited by the rule set of the trusted central institution and not by the individual rules of a given virtual world. Moreover, the creation and maintenance of a trusted central institution is required. Such a trusted central institution may become a bottle-neck for the overall system. In addition, objects that have failed the rule check of the trusted institution and that have therefore been adapted (either through a reset or through a modification) can only be used in their adapted form, even if they are brought back to the same virtual world wherein they were previously modified in a way that caused the failure of the rule check.

In view of these shortcomings of prior art, it is the object of this invention to allow objects to be taken from one virtual world to a different virtual world and from that new virtual world, the object may be taken to yet another virtual world, and so on. Furthermore, it is the object of this invention that, for a given virtual world, all modifications of an object that are unacceptable to this virtual world should be treated as if they were non-existent. At the same time, all modifications of an object that are made by any virtual world must be accessible for those virtual worlds that consider them acceptable. Furthermore, these possibilities should be accessible without the necessity of having a trusted central institution.

### SUMMARY OF THE INVENTION

The object of the invention is achieved by a method in which the object is defined as a sequence of modifications and for each modification the virtual world in which the modification occured is identified.

In accordance with the invention, users may take objects from one virtual world to a different one in a way that gives the virtual world to which the object is taken, the ability to decide which modifications of the object are acceptable and which are not. Based on this information, the virtual world to which the object is taken can regard the object as if only the modifications had happened that are acceptable for this virtual world.

In a preferred embodiment of the invention, for a given virtual world, modifications to the objects which are not acceptable to that given virtual world are rejected. Rejected modifications can either be ignored or replaced with another alternative modification. However, regardless of whether or not the modification is ignored or replaced, the rejected modification remains a part of the object and is contained in the sequence of modifications when the object leaves the given virtual world.

In a further preferred embodiment of the invention, monotonically increasing numbers are assigned to each modification in a given virtual world. These sequential numbers can be examined to assure that no particular modification of an object has been removed from the object's description.

In an embodiment of the invention, information concerning the object is stored in a trusted central institution. This information can include a highest sequence number that the object has in each virtual world. This embodiment has the advantage of avoiding the necessity for a given virtual world to contact all other compatible virtual worlds in order to examine the highest sequence number given to an object by that virtual world. In this fashion modifications to the object which may be undesirable to the user (loss of strength etc.) cannot be deleted without the virtual world recognizing the change.

In a preferred embodiment of the invention, the object is an avatar representation of a user in a role-playing game. This embodiment has the advantage of applying the method in accordance with the invention to an ever increasingly popular and useful application, in particular for online role-playing games via networks of computers.

In a preferred variation of this last embodiment, the modification is a change in experience, strength, item or equipment. This particular variation has the advantage of performing modifications which are particularly useful in role-playing games.

In a preferred embodiment of the invention, a signature of a server simulating a given virtual world can be examined. This embodiment allows identification of the server in which a particular modification was made.

The invention is also directed to a device for using, presenting, transmitting and storing objects in and by virtual worlds comprising means for defining the object as a sequence of modifications, means for identifying a virtual world in which a modification of the object occurs, and means for storing each modification of the object as well as its identification of the associated virtual world in which that modification has been made. The device has the advantages associated with the corresponding method mentioned above in accordance with the invention.

The invention is also directed to a storage medium containing machine readable code for carrying out the method of the invention.

Further details, advantages and aspects of the invention can be abstracted from the accompanying description of a preferred embodiment in association with the drawing. Elements recited in the claims and described in association with the preferred embodiment of the drawing can be important to the invention either alone or in combination. The following embodiment is not to be considered a full enumeration of inventive configurations but has exemplary character only.

### BRIEF DESCRIPTION OF THE DRAWING

FIG. 1 shows a schematic representation of the creation of an avatar on a given server A;

FIG. 2 shows a modification of the avatar on a different server B;

FIG. 3 shows an additional modification of the avatar on a server C; and

FIG. 4 shows the status of the avatar as perceived by still another server D.

### DESCRIPTION OF THE PREFERRED EMBODIMENT

In accordance with the invention, objects are regarded as a sequence of modifications. For each element in this sequence, the virtual world in which the modification has been performed is identified. Elements in this sequence may be aggregated if they have been conducted within the same virtual world. The creation of an object is an initial modification of the object and is therefore treated in the same way as all other modifications. The identification of the virtual world in which a modification has been performed is done by appropriate means. In a computer-based virtual world this may be done by means of a cryptographic signature.

When an object is brought into a virtual world, each element in the sequence of modifications may be checked for acceptability. This check could be based on the object, the modification, the virtual world in which it was performed or other criteria. If the combination is acceptable for the virtual world into which the object is brought, then the modification has effect. If this is not the case, the modification is ignored or modified for this virtual world. In this virtual world, the object will be treated as if the unacceptable modification never happened or a different modification happened instead. However, even if a modification is not acceptable (and therefore ignored or replaced) in a given virtual world, it remains part of the object and is still contained in the sequence of modifications when it leaves this virtual world.

The acceptable combinations of objects, modifications, and virtual worlds in which the modification was performed (and possibly other criteria) as well as replacements for unacceptable modifications can be freely configured by the person/organization responsible for the given virtual world.

Objects that are constructed as a sequence of modifications, with each modification being attributed to one virtual world, can be handed directly from one virtual world to the next virtual world. They may also be handed to the user which, in turn, can store them and later on import them in a different virtual world. Therefore a trusted central institution is not required. It may be used as an optional element to store object information, but it is not mandatory.

In some cases an object may be modified in a way that is disadvantageous to the user. In order to make sure that these modifications are not deleted, a virtual world may include a monotonically increasing number (called a sequence number) associated with each modification, which is stored in the sequence. It furthermore remembers the pair of the object and the highest sequence number that it has assigned to the object. When an object is brought into a virtual world, the virtual world may check with each other virtual world from which it accepts modifications to determine the sequence numbers that the object should have. If these do not match the sequence numbers in the sequence of modifications of the object, then the object may be rejected.

In order to avoid communication with multiple virtual worlds, a trusted centralized institution may also be used to hold the information about the objects and the highest sequence numbers that the object has in all virtual worlds. Clearly, this trusted central institution is optional. In fact, one main advantage of the invention is that objects can be taken from one virtual world into a different one without the need for such a trusted central institution. Each individual virtual world can then decide on whether or not a certain modification performed within a certain virtual world for a certain object is acceptable. If such a modification is not acceptable, the object can still be brought into the world by ignoring or replacing the unacceptable modifications. However, all modifications that have ever been performed on an object remain accessible. No modification is ever lost. If the method used for identifying in which virtual world a modification has been performed is reliable, the invention guarantees that only those modifications are taken into account that are acceptable in a given virtual world.

Online role-playing games (online RPGs) are one popular type of virtual world. With an online RPG a virtual world is simulated on computers which are connected by a network (e.g., the Internet). A human can participate in such an online RPG over a computer network by using appropriate computer programs. While participating in an online-RPG the player has a representation in the virtual world. This representation of a user is referred to as an avatar. An avatar is an object in the sense of the present invention. By controlling his avatar the user solves problems, fights monsters, and gains items within the virtual world. Therefore the avatar (and the items it carries) is modified within the virtual world. Usually the computer(s) on which the virtual world is simulated is (are) called the server(s) and the computer that is used to display the game state to the user is called a client.

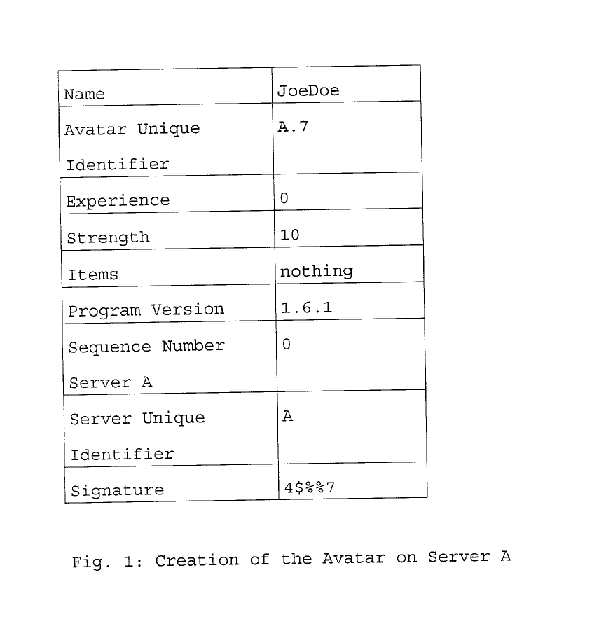

As an initial step, a user will typically create an avatar as his representation. The user might choose to create an avatar on a server with the unique identifier A (A could, for example, be the server's IP address or the MAC address of the server's network interface). During the creation process the avatar is assigned a name, a globally unique identifier (which could be constructed from the server's unique ID plus a counter to distinguish avatars that have been created on the same server), character attributes such as strength, and an initial experience value of 0. Since the creation of a character is considered to be an initial modification, it is assigned a sequence number for server A, the unique identifier for server A is included, and the whole modification is cryptographically signed by server A. Depending on where the sequence numbers of the modifications are kept, server A may store the Avatar Unique Identifier in combination with the sequence number for server A, or it may send this information to a trusted central institution so that it can be maintained there. By way of example, this embodiment assumes each server stores the sequence number of its modifications, so that no central institution is required. After the creation of the character is finished, the description of the avatar, as shown in FIG. 1, is handed back to the (computer of) the user.

Now suppose that after the creation of the avatar the user wants to start playing on a server B. The user therefore transmits the description of the avatar to server B. Server B then determines which modifications to the avatar are acceptable. Currently there is only one modification, namely the creation of the avatar. Therefore, server B checks if it trusts server A regarding the creation of the avatar. This is possible since the signature guarantees that the creation has indeed been performed by server A. Let us assume that server B has been configured to accept the “create” modification from server A. The only existing modification is therefore accepted. Server B then checks with all servers from which it accepts any kind of modification to check if they have sequence numbers for the avatar. This is only the case for server A. A will respond with sequence number 0 which matches the sequence number of the last (and only) event from A in the description of the avatar. B therefore accepts the avatar and the user can start playing the avatar on server B.

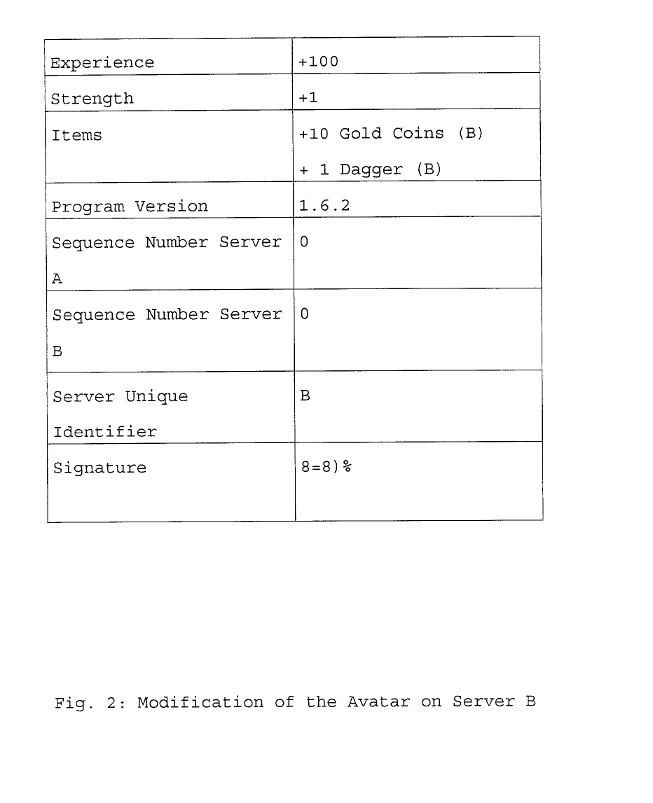

After the user is done playing, server B will send the signed modifications back to the user. These are depicted in FIG. 2. From these modifications it can be seen that the avatar has gained some items, one point of strength and some experience.

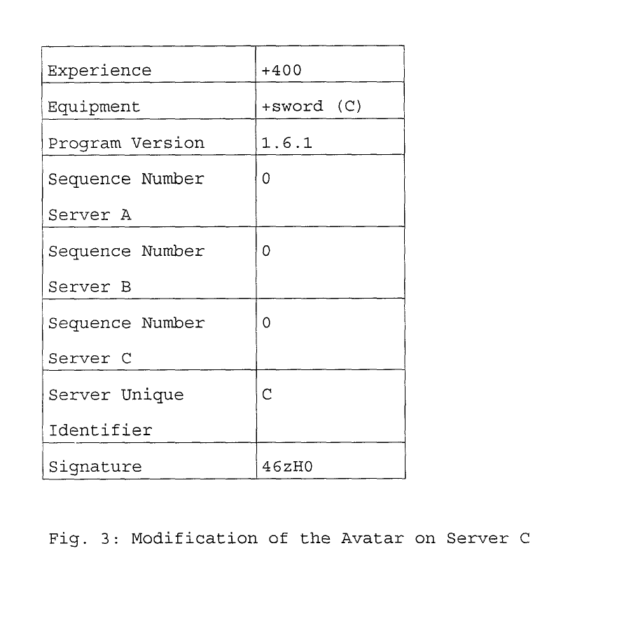

Now the user decides to play on a third server C. He/She transmits all information about the avatar to server C which then checks if the modifications are acceptable or not. In the event that C finds all modifications acceptable, server C then requests the sequence numbers of this avatar from all servers from which C accepts modifications. Replies are given from A and B which fit the description transmitted by the user to server C. Therefore the user can start playing with the avatar. Again, after the user is done playing, server C will send the signed modifications back to the user. These are depicted in FIG. 3.

From FIG. 3 it can be seen that the avatar has gained a sword. Furthermore the avatar has received 400 more experience. In our example, this would let him reach a new level of experience (at 500 experience points) which enables him/her to defeat opponents more easily and it also adds 5 points of strength. Since this can be derived from the amount of experience there is no need to put this in the modification that is signed by C.

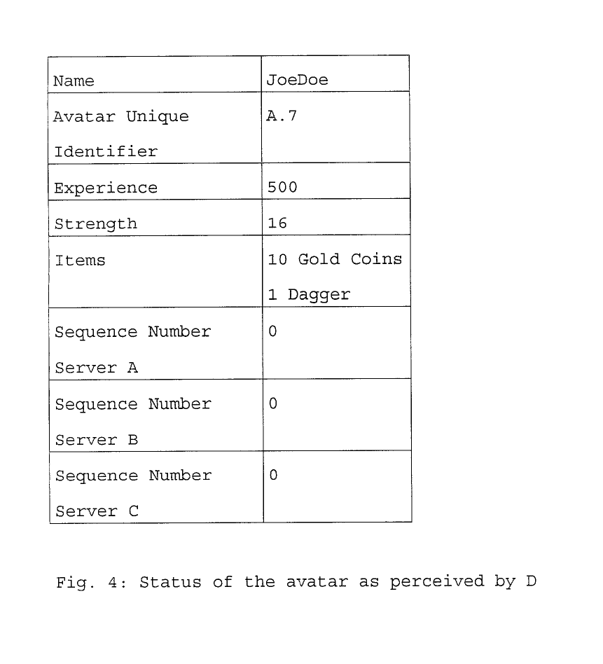

Now the user decides to play on a fourth server D. He/She transmits all information about the avatar to server D which then checks if the modifications are acceptable or not. Server D then requests the sequence numbers of this avatar from all servers from which D accepts modifications. Replies are given from A and B and C which fit the description transmitted by the user to server D. Suppose that, based on the modifications and the servers on which they were performed, D accepts the changes from A and B. From C it accepts only the modification in experience but no modifications of the equipment. The status of the avatar, as perceived by D will then be as shown in FIG. 4. Thus, the user is able to play on server D even though the avatar has been in a world that is not trusted completely by D.

An example of additional information that can be used by a server to determine whether a modification should be accepted or not is the program version associated with a particular modification. A certain program version of a given virtual world may allow cheating to take place (e.g., to counterfeit items). It is then possible to take that version number into consideration and to ignore modifications that have been performed under the unaccepted program version of a given virtual world.

As illustrated above, the user can not add, alter, or delete any modification. Moreover, each virtual world can be configured to accept only those changes that are acceptable to the controller of this virtual world.

I claim:

1. A method for using, presenting, transmitting, and storing objects in and by virtual worlds, the method comprising the steps of:
a) defining the object as a sequence of modifications;
b) identifying a virtual world in which a modification of the object has taken place; and
c) storing each modification of the object and each identification of an associated virtual world in which that modification has been made.

2. The method of claim 1, further comprising rejecting, for a given virtual world, those modifications to the object which are not acceptable to that given virtual world.

3. The method of claims 2, wherein rejected modifications are ignored.

4. The method of claim 2, wherein rejected modifications are replaced.

5. The method of claim 2, wherein non-accepted modifications remain a part of the object and are contained in said sequence of modifications when the object leaves that given virtual world.

6. The method of claim 1, further comprising assigning a monotonically increasing sequence number of each modification in a given virtual world.

7. The method of claim 6, further comprising examination of said sequence number to ensure that no modification of an object has been removed from a description of the object.

8. The method of claim 1, further comprising maintaining information about the object in a trusted central institution.

9. The method of claim 8, wherein said information comprises highest sequence numbers that the object has in each virtual world.

10. The method of claim 1, wherein the object is an avatar representation of a user in a role-playing game.

11. The method of claim 10, wherein said modification is a change in at least one of an experience, a strength, an item and equipment.

12. The method of claim 10, wherein step b) comprising the step of examining a signature of a server simulating a virtual world.

13. A device for using, presenting, transmitting and storing objects in and by virtual worlds, the device comprising:
a) means for defining the object as a sequence of modifications;
b) means for identifying a virtual world in which a modification of the object occurs; and
c) means for storing each modification of the object and each identification of an associated virtual world in which that modification has been made.

14. A storage medium containing machine readable code for carrying out the method of claim 1.
